(19) United States
(12) Patent Application Publication
(10) Pub. No.: US 2012/0251317 A1
(43) Pub. Date: Oct. 4, 2012

(54) WIND POWER PLANT

(76) Inventor: Marc Reitmaier, Schlagen (DE)

(21) Appl. No.: 13/438,354

(22) Filed: Apr. 3, 2012

(30) Foreign Application Priority Data
Apr. 4, 2011 (DE) 10 2011 015 970.3

(51) Int. Cl. F03D 7/00; F03D 11/00

(52) U.S. Cl. 416/61

(57) ABSTRACT

A wind power plant having a nacelle and a rotor and a data transmission system which is suitable and equipped for transmitting data from a first data contact device in the nacelle through a data transmitter to a second data contact device in the rotor which is rotatable relative to the first data contact device. The first data contact device is connected with a first DSL modem which is connected with a second DSL modem via the data transmitter. The second DSL modem is connected with the second data contact device. The data transmitter is provided between the first and second data contact devices.

### BACKGROUND

The present invention relates to a wind power plant having a nacelle and a hub and a data transmission system to transmit in particular operational and control data or other data between a contact point at the nacelle and a contact point at the hub rotating relative thereto.

A great variety of wind power plants have become known in the prior art in which data is transmitted from a first data contact at the nacelle to a second data contact movable relative thereto and rotating along with the hub. As a rule data connection is serial through slip rings with which data is transmitted from the stationary nacelle to the rotating hub and vice versa. These slip ring transducers may have multiple contacts so as to allow the concurrent presence of two, three or more electrically conducting connections via the slip ring transducer.

These slip ring transducers are e.g. used in wind power plants for transmitting electrical current and data. One design of wind power plants shows a substantially horizontal rotor axis, known as a horizontal axis wind power plant (HAWT). In these wind power plants, a tower has arranged on it a nacelle in which may be disposed among other things one or more generators, converters, controls, transformers, and optionally transmissions. A so-called rotor comprising a hub with rotor blades attached to it is supported at the nacelle rotatable about a substantially horizontal axis. The rotor drives the generator or generators, optionally with a transmission in-between. For adjusting the angle of attack of the rotor blade to the wind, each of the rotor blades is attached to the hub to rotate about its longitudinal axis.

In existing wind power plants, the rotor speed is as a rule adjusted to the wind speed attacking the rotor blades in a first operating range. The higher the wind speed, the higher the rate of rotation. In a second operating range beginning as the rated capacity of the wind power plant is reached, the rate of rotation is maintained constant up to a specified wind speed to protect the wind power plant from overstressing.

To this end it is known to suitably adjust the rotor blade angle of attack and thus to correspondingly limit the rate of rotation of the wind power plant.

For adjusting the angle of attack of a rotor blade e.g. electromotor drives may be incorporated into the rotor controlled by means of frequency converters. The currently set angle of attack of the rotor blades tends to be captured via an absolute rotational angle transmitter provided at the rotor blade. Furthermore, sensors tend to be increasingly provided in the rotor blades for capturing not only the angle of attack of the rotor blades but for example also the distance of the rotor blades from the tower or bending of the rotor blades, or for detecting the frequency and strength of vibrations in the rotor blade.

The use of frequency converters and sensors in the rotor blades requires data transmission from the hub, which is a rotating part of the wind power plant, to a stationary part of the wind power plant, which usually is the nacelle. As a rule, the wind power plant controls are located there or else in the tower. A safe operation of a wind power plant inevitably requires controls operating safely and reliably in any and all operating conditions.

Many wind power plants shut down from a specific maximum wind speed permitted, the so-called shutdown wind speed to avoid overstressing. To this end the rotor blades are turned to the so-called feathering position. The wind power plant restarts automatically when the average wind speed is below a specified threshold for a certain time period. This allows for reliably avoiding overstressing of the wind power plant. It is a drawback, however, that in phases of strongest winds where the power production yield might be highest the wind power plant is shut off to avoid damage. Operation will not restart until the wind speed lies beneath the maximum strength allowed for a prolonged period of time. At any rate, a reliable and safe data transmission between the nacelle and the rotor is required for the controls to optimally control operation and for the system to reliably shut down in the case of too strong winds or troubles.

Up to now, data and electric current are transmitted from the nacelle via slip rings to the rotor. The data transmission thus far employed only allows a low data rate which also does not always work reliably in the long run. As a rule, the slip rings need cleaning annually or after two years at the latest to allow continued data transmission. Data transmission occurs via bus systems such as interbus, CAN or the like with the data being transmitted serially.

When just one single sliding contact fails, then the entire system must be shut down because reliable data transmission is no longer ensured.

Data transmission via an ethernet cable—which would be fast enough—only works in standstill as a rule since ethernet cables, being twisted-pair cables, must have pairs of twisted wires to eliminate environmental interferences. In transmitting via a slip ring, however, the contacts can certainly not be allowed to be twisted within the slip ring such that considerable interference may occur at the slip ring which massively affect data transmission reliability. In rotary operation transmission is not possible at all or it will be unreliable.

Serial data transmission will only allow a narrow bandwidth of the data signals transmitted which is not sufficient given increasing use of sensors in the rotor blades. When additional sensors are intended which extend for example in the shape of a glass fiber around the entire rotor blade and with which optical damping can be measured which depends on the rotor blade vibrations, then a broader bandwidth of data transmission is required within the wind power plant.

Basically it is possible to transmit data via radio from the rotor blades to the controls. Present-day WLAN systems comprise the bandwidth required and can basically very reliably transmit the data as desired across the required short distance. A drawback is the limited number of available channels.

Many operators for example of wind power plants wish to advertise their systems or put the installed system to additional use for example by retrofitting the wind power plant with webcams to take pictures or record a video stream of the surroundings. Data transmission to the webcams or to the temperature and weather sensors is often performed using WLAN systems or else radio systems in general transmitting in the same frequency band. Employing these WLAN systems or other radio systems subsequently installed by the operator may periodically or permanently seriously interfere with radio transmission from the rotor blades to the controls. When identical radio channels are chosen, and if adverse circumstances accumulate, interferences may occur such that reliable data transmission between the central control of the wind power plant and the hub or the rotor can no longer be guaranteed.

If, however, there is no data connection between the controls and the rotor for a certain length of time, the wind power plant will be shut down for safety reasons. A failing radio or wireless connection can thus result in considerable economic damage to the operator since the wind power plant is shut down unnecessarily only because data transmission is less than reliable. In other wireless systems, reliable operation cannot always be safely ensured either. Although bluetooth basically allows undisturbed signal transmission via frequency hopping, interference or failure are still possible. Moreover the transmissible data rate is not sufficient.

Although the shortness of the distance to be bridged makes a radio connection appear suitable, undisturbed data exchange via radio cannot always be safely ensured due to unforeseen installation of webcams and the like by the operator or proprietor. Even brief disturbances in radio data transmission may result in considerable economic damage when the wind power plant shuts down. Also, searching for the cause of problems may prove to be difficult in the case of radio disturbances.

### SUMMARY

It is therefore the object of the invention to provide a wind power plant having a data transmission system with which to permanently enable reliably high signal transmission rates between the nacelle and the hub.

A wind power plant or wind turbine according to the invention comprises a nacelle and a rotor and at least one data transmission system. The data transmission system is suitable and provided for transmitting data from a first data contact device in the nacelle via at least one data transmitter to a second data contact device in the rotor rotatable relative to the first data contact device. The first data contact device in the nacelle is connected with a first DSL modem that is connected with a second DSL modem via the at least one data transmitter. The second DSL modem is connected with the second data contact device in the rotor. The data transmitter is disposed between the first and second DSL modems.

The data transmission system according to the invention has many advantages. One considerable advantage of the data transmission system according to the invention consists in that data connection via the data transmitter is realized through two DSL modems. DSL modems (Digital Subscriber Line modems) allow reliable data transmission for example via the telephone network over comparatively long distances up to distances in the range of several kilometers. The telephone network consists as a rule of pairs of copper wires which for example do not require twisting to avoid interference. This is why a DSL connection is well suitable to be used with components disposed movable relative to one another and in particular rotatable relative to one another.

It is for example possible for the data transmitter to be configured as a slip ring. Data transmission via a DSL modem modulated via such a slip ring is reliable. A shielded connection is not required for transmission via DSL modem since no twisted cables need to be used. While radio transmission which is provided for comparatively short distances has only shown low reliability, DSL transmission which is provided for comparatively far longer distances can guarantee data transmission via slip rings between the nacelle and the rotor and especially the hub at high data rates.

The second data contact device is provided rotatable relative to the first data contact device and is disposed in the rotating part of the wind power plant. Preferably the data transmitter comprises a slip ring comprising at least one sliding contact and in particular at least two sliding contacts. Data transmission via DSL allows the ability to safely transmit the data at high data rates. Small and tiny interferences in data transmission are reliably detected and eliminated by automatic signal processing. This is why one single data connection via two sliding contacts provides via the DSL modem a data transmission that is considerably more reliable than is serial data transmission through slip rings as in the prior art. This is why the slip ring can operate for longer periods between maintenance services.

In particularly preferred configurations at least four sliding contacts are provided. It is also possible to use more than four sliding contacts. The sliding contacts may be provided at one single slip ring or at multiple slip rings.

It is particularly preferred to use four or more sliding contacts since four sliding contacts allow two parallel data connections. The first data connection runs via two sliding contacts and a second data connection, via another two sliding contacts. This allows a redundant system layout. While all of the four sliding contacts are reliably available for transmitting data a doubled data rate may be provided while in the case that one single sliding contact fails, one data connection is still established which can transmit adequate data volumes.

In the case that six sliding contacts are used it is certainly possible to provide three separate data connections such that data transmission will still be enabled if two or even up to four sliding contacts should fail. The redundancy allows to still further increase what is an already increased operational reliability. The sliding contacts may be serviced during scheduled routine maintenance.

Preferably an alarm is triggered in the data transmission system when a sliding contact ceases to reliably transmit data. This signal may be provided to the operator for the operator to provide for cleaning of the sliding contact and preferably of all the sliding contacts in the scope of the next maintenance scheduled. While data transmission is operating reliably via at least one data connection the system does not need to be shut down. This allows to attain increased annual operating hours so as to improve utilization and thus to increase the yield.

Preferably the data transmission system is suitable to service a plurality of sensors in a rotor blade or in all the rotor blades in a wind power plant with data.

Typical wind power plant systems these days can reach hub heights of up to 140 m or even more. The length of a rotor blade will be for example 60 m and its weight can reach 20 metric tons or more. This is why the investment costs and in particular the mounting costs per rotor blade of a wind power plant are very high. These rotor blades may suffer environmental damage in operation. For example lightning may strike a rotor blade and cause local or even large-area damage to the rotor blade. Damage from birds is also possible. A new rotor blade involves huge costs. This is why wind power plant operators try to repair damaged rotor blades instead of immediately exchanging them. To capture the extent and kind and location of any damage up front, the invention allows the ability to increasingly incorporate sensors into rotor blades and the rotor so as to allow highly sensitive capturing of the condition of each of the rotor blades. The sensor data allows to greatly simplify repairs since most of the damage is known from the start.

Preferably at least one of the DSL modems is configured as an ADSL modem (asymmetric DSL). In the case of asymmetric DSL the data transmission speed is higher in one direction than in the other. This is why SDSL modems (synchronous DSL) are preferably used in which the data transmission rate is the same in both directions. In many cases the use of ADSL is preferred though.

Particularly preferably SHDSL modems (Single-Pair High-Speed Digital Subscriber Line modems) are used which are for example standardized under G.SHDSL standard.

Data is transmitted in particular in a frequency range below 10 MHz and in particular below 2 MHz. Data is transmitted particularly preferably at frequencies between 50 kHz and 1500 kHz and in particular in a range between 100 kHz and 1000 kHz.

The wind power plant according to the invention preferably comprises at least one supporting structure and at least one rotor blade provided rotatable thereat. At least one sensor may be provided at least at one rotor blade to allow controlling the operation in dependence on ambient conditions and/or the state of the rotor blade. The supporting structure can in particular be provided with at least one control device which is in data connection via at least one data connection with the at least one sensor in the rotor blade. The data connection runs via a first data contact device with a first DSL modem to a data transmitter which is connected with a second data contact device via a second DSL modem. The second data contact device is directly or indirectly connected with the sensor.

The wind power plant can guarantee reliable data transmission from the rotating part of the wind power plant to the stationary part at a high data rate. Data transmission is enabled at high data transmission rates without resorting to what may be an unreliable radio link. The data connection allows transmission of control, measurement, and operational data and also other data between the hub and the nacelle.

At the nacelle of the wind power plant a rotor is provided. The rotor comprising a hub and rotor blades attached to the hub. The rotor is rotatable with respect to the nacelle.

The supporting structure in particular configured as a tower preferably also serves to receive parts of the controls for controlling the operation. In at least one rotor blade at least one actuator or at least one adjusting device for varying the rotor blade is provided.

### BRIEF DESCRIPTION OF THE DRAWINGS

Further advantages and features of the present invention can be taken from the exemplary embodiment which will be described below with reference to the enclosed figures.

The figures show in:

FIG. 1 a schematic illustration of a wind power plant; and

FIG. 2 a schematic illustration of the data transmission system of the wind power plant according to FIG. 1.

### DETAILED DESCRIPTION

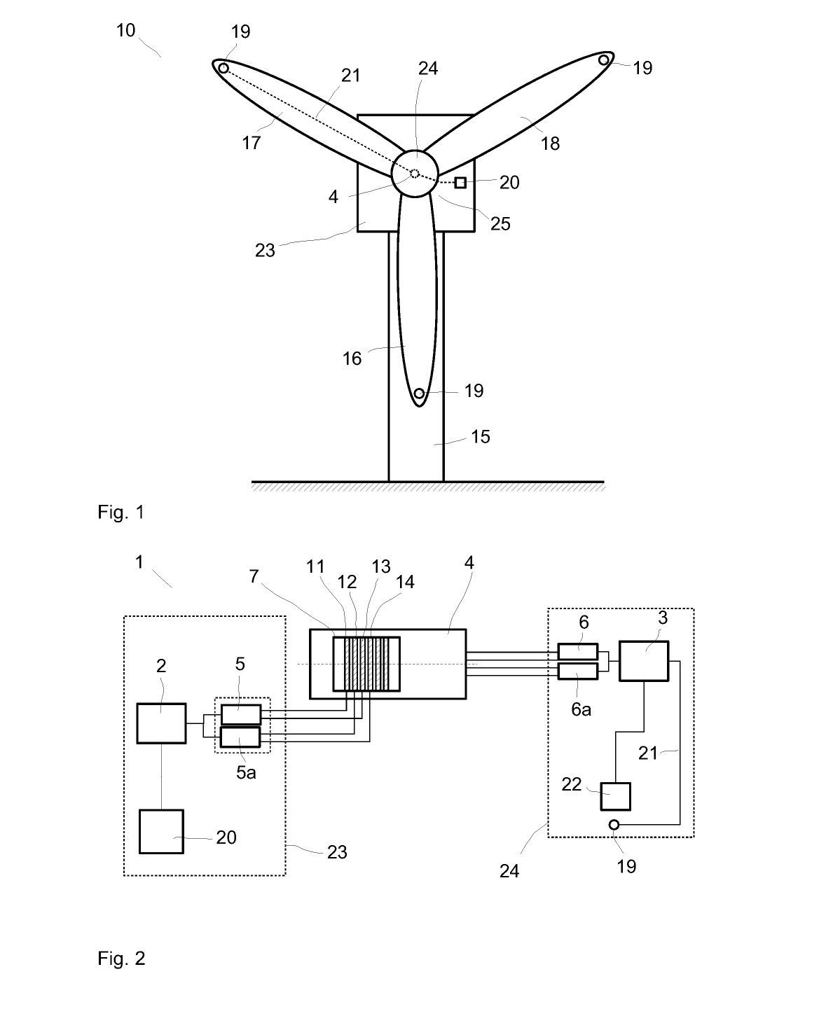

The FIGS. 1 and 2 illustrate an exemplary embodiment of the invention wherein FIG. 1 schematically shows a wind power plant 10 presently comprising a tower 15, a nacelle 23, a hub 24 and three rotor blades 16, 17 and 18 symmetrically arranged about the circumference and supported rotatable relative to the tower 15. The rotor 25 comprises a hub 24 and rotor blades 16, 17 and 18. The rotor with the rotor blades 16, 17 and 18 is rotatable around a substantially horizontal axis. For orienting the wind power plant 10 by the wind direction the nacelle 23 is provided to pivot about an approximately vertical axis. The steering of the wind power plant 10 into the wind is preferably motor-controlled.

The angle of attack of the rotor blades 16, 17 and 18 is variable to adjust the rotational speed of the rotor blades to the wind conditions. As the maximum rotational speed is reached or a specific limit rate of rotation is reached, the angle of attack of the rotor blades is incrementally or continuously varied such that the maximum of the permissible operational speed is reliably not exceeded. The system may optionally have to be shut down if the wind gets too strong.

For adjusting the angle of attack each of the rotor blades 16, 17 and 18 is provided with at least one actuator 22 as is schematically shown in FIG. 2 only.

At least one sensor 19 is provided in each of the rotor blades 16, 17 and 18. Preferably a plurality of sensors are disposed to not only capture the angle of attack of the rotor blades 16-18 but also to monitor and capture a plurality of other operating states of each of the rotor blades 16-18. This includes for example the type and strength of vibration of each of the rotor blades 16-18. It is also possible to capture not only vibration of each of the rotor blades on the whole but to detect local surface oscillations on the rotor blades 16-18 for early diagnosis of local defects so as to enable easy repairs and maintenance of the rotor blades without requiring exchange of an entire rotor blade.

It is also possible and preferred to monitor the axial distances of the rotor blades from the tower 15 to reliably avoid collisions.

To ensure all the required data between the central controls 20 and the locally provided sensors 19 as well as associated actuators 22, a data transmission system 1 is provided which allows highly reliable data transmission of up to 5 MBit per second and in particular up to 15 MBit per second or more through 2 wires. To this end the data transmission system 1 comprises a first data contact device 2 in the nacelle 23 which is connected with a first DSL modem 5.

The DSL modem is presently configured as an SHDSL modem which allows data transmission of up to 15 MBit per second through 2 wires. The two wires of the first DSL modem 5 are connected with a slip ring 7 where they are connected with the sliding contacts 11 and 13.

For additional data transmission and for redundancy another “first” DSL modem 5a is provided which is connected with the sliding contacts 12 and 14 of the slip ring 7.

The sliding contacts 11-14 are connected 1:1 with corresponding conductors with the sliding contacts 11 and 13 contacting a second DSL modem 6 which is connected with the second data contact device 3. Alternatively another “second” DSL modem 6a is provided which is connected with the sliding contacts 12 and 14 of the slip ring 7.

The first DSL modems 5 and 5a and the second DSL modems 6 and 6a together provide two data connections 8 and 9 which in normal operation either work in redundancy or else attain double the conceivable bandwidth.

The first modems 5 and 5a may be combined in a housing or may even form a modular unit. The dashed line inserted in FIG. 2 around the modems 5 and 5a illustrates this clearly. The second modems 6 and 6a can as well be incorporated to form one joint modular unit.

In case that one of the sliding contacts 11 to 14, e.g. sliding contact 11, loses reliable contact with the slip ring 7, then one data connection 8 or 9 fails. Even then reliable data transmission is possible through the other of the data connections 9, 8 so as to ensure continued operation of the wind power plant 10. When a second sliding contact fails it is possible that one data connection 8 or 9 is still fully maintained if this is for example the sliding contact 13. Thus even in the case of failure of two sliding contacts 11 and 13 or 12 and 14 a continued reliable operation of the wind power plant is possible.

In any case, as a failure of a sliding contact 11-14 is detected, an alarm signal is emitted signaling to the operator that the system and in particular the sliding contacts require servicing as soon as possible. For example in a scheduled shutdown of the system 10 the corresponding sliding contact can then be cleaned or exchanged. In this way operational reliability and availability of the system 10 is considerably increased.

In a conventional known—prior art—signal transmission performed serially through the sliding contacts the failure of even one single sliding contact may result in failure of the entire system.

The data transmission system 1 according to the invention providing data transmission through DSL modems 5, 6 and a slip ring 7 attains a considerably increased outage safety. By way of data being transmitted in a wide frequency range between approximately 100 KHz and 1000 KHz, transmission is not only done in a narrow frequency band but in a wide frequency band so as to allow reducing the signal strength which further increases outage safety.

Since data transmission is virtually capacitive, a still reliable data transmission is even conceivable with increasing contact resistance.

The first data contact device 2 in the nacelle 23 and the second data contact device 3 in the hub 24 may each be connected with conventional ethernet cables so as to allow the use of conventional components elsewhere in the system.

The invention allows the employment of condition monitoring systems in the rotor blades for close-meshed operation monitoring. Measuring systems and de-icing systems providing for reliable de-icing of the rotor blades may be employed and precisely target-controlled. It is possible to use for example a webcam which is received in the rotor blade and further monitors operation or for example provides images in the internet for information or advertising purposes to furnish pictures from the rotating rotor blades.

Or else, the entire system can be speed-controlled due to the sensors provided in the rotor blades.

Controlling the system 10 by way of the sensor data obtained is also preferred. It is for example possible for the provided operational speed to be adapted in dependence on the sensor data of each of the rotor blades 16 to 18. For example in the case of minor damage to one of the rotor blades 16 to 18 due to birds or the like, the permissible operational speed may be derated to prevent further damage to the system 10 while energy can still be produced until repairs are made. When rotor blades need to be exchanged, long lead times must be expected as a rule since the necessary crane trucks provided therefore tend to be booked up for a long time ahead. If the damage allows continued operation at reduced performance, individual sensor controlled operation might be possible so as to maximize availability and production of electricity.

The individual sensors 19 in the rotor blades 16 to 18 are connected via data lines 21 with the data transmitter 4 and via the slip ring 7 in turn with the central controls 20. The central controls 20 are preferably disposed in the tower 15 or in the nacelle 23. Or else it is conceivable for the central controls to be disposed in the rotating part of the wind power plant 10.

On the whole the invention allows increased availability of wind power plants 10. In particular the providing of multiple, redundant data connections 8, 9 etc. reliably prevents that transmitting the signals from the central controls into the hub fails beyond the so-called time-out period. In this way one prevents automatic emergency system stops in which the rotor blades automatically turn as fast as possible out of the wind to the feathering position to stop operation of the system. In the case of strong winds this may cause extreme loads on the system 10 since the entire tower will swing back as the wind load is removed. These high loads are largely avoided by the data transmission system according to the invention since data transmission is more rugged and operates more reliably even with high signal transmission speeds.

What is claimed:

1. A wind power plant, comprising:
a nacelle and a rotor and a data transmission system which is suitable and equipped for transmitting data from a first data contact device in the nacelle through at least one data transmitter to a second data contact device in the rotor which is rotatable relative to the first data contact device;
the first data contact device is connected with a first DSL modem which is connected with a second DSL modem through the at least one data transmitter;
wherein the second DSL modem is connected with the second data contact device; and
wherein the data transmitter is provided between the first and second data contact devices.

2. The wind power plant according to claim 1 wherein the data transmitter comprises at least one slip ring having at least one sliding contact.

3. The wind power plant according to claim 2 wherein the at least one slip ring comprises at least two sliding contacts.

4. The wind power plant according to claim 3 wherein at least four sliding contacts are provided.

5. The wind power plant according to claim 1 wherein at least two redundant data connections are provided.

6. The wind power plant according to claim 3 wherein at least two of said sliding contacts each are connected in parallel.

7. The wind power plant according to claim 1 wherein at least one of the first and/or second DSL modems is configured as an ADSL modem.

8. The wind power plant according to claim 1 wherein at least one of the first and/or second DSL modems is configured as an SDSL modem and in particular an SHDSL modem.

9. The wind power plant according to claim 8 wherein data is transmitted in a frequency range below 10 MHz and in particular below 2 MHz.

10. The wind power plant according to claim 9 wherein data is transmitted in a frequency range of 50 kHz to 1500 kHz.

11. The wind power plant according to claim 1 having at least one supporting structure and at least one rotor blade provided rotatable thereat and at least one sensor at the rotor blade, wherein the supporting structure is provided with a control device which via the at least one data connection is in data connection with the at least one sensor in the rotor blade.
